(19) United States
(12) Patent Application Publication
(10) Pub. No.: US 2006/0091878 A1
(43) Pub. Date: May 4, 2006

(54) Radio frequency process control

(75) Inventors: David R. Wilson, Platteville, CO (US); George I. Noyes, Pinecliffe, CO (US)

Correspondence Address: CR MILES, P.C., 1 OLD TOWN SQUARE, SUITE 200 B, FORT COLLINS, CO, 80524, US

(73) Assignee: Frontier Engineering, LLC

(21) Appl. No.: 11/057,788

(22) Filed: Jan. 6, 2005

Related U.S. Application Data
(60) Provisional application No. 60/534,415, filed on Jan. 6, 2004.

(51) Int. Cl. G01S 3/02

(52) U.S. Cl. 324/76.14

(57) ABSTRACT

A method and apparatus of providing and improving process controls when using RF power sources in medical, industrial, or scientific processes. A further improvement results in sampling RF energy in the fundamental frequency and its related harmonic frequencies. The process control employs sampling, splitting, filtering and subsequently measuring differences between the fundamental frequency amplitude and a reference frequency amplitude and furthermore measuring the difference between the fundamental frequency amplitude and each related harmonic. Data is further digitized, processed by one or more microprocessors, time stamped and sent to upstream control systems to enable process control.

This United States non-provisional patent application claims the benefit of U.S. provisional patent application 60/534,415, filed Jan. 6, 2004, including ten drawings, incorporated by reference in the entirety herein.

### I. FIELD OF THE INVENTION

The present invention relates to Radio Frequency (RF) Process control. More particularly, it relates to a method and apparatus of process control of RF energy in the fundamental and related harmonic frequencies when RF energy is employed in medical, industrial or scientific applications.

### II. BACKGROUND OF THE INVENTION

The use of Radio Frequency (RF) power (energy) is used throughout the medical, industrial, and scientific communities. A process employing RF energy typically will have concerns over the control of the fundamental RF amplitude and its related basic harmonic frequencies. When either the fundamental RF frequency or any of the basic harmonic frequencies change in amplitude, RF energy control becomes a concern.

Instrumentation, Scientific and Medical (ISM) Frequency Bands are typically used for RF energy applications. ISM instrumentation bands run in three general ranges, 902-928 MHz, 2.4 to 2.4835 GHz, and 5,725 to 5.850 GHz.

The medical industry employs RF energy to pinpoint an area of concern on a tissue and will utilize the RF energy to subjugate or destroy an area. If the basic fundamental RF frequency Fₐ and/or combinations of any its harmonic frequencies are stable, tissue can be probed and RF energy emitted to subjugate or destroy and area of concern. However, if the Fₐ and/or any harmonic were to become unstable, tissue could be harmed beyond the initial intent. For example, applications for removing tumors are extremely RF energy control sensitive. Harmonics instability could be particularly harmful in that the tissue itself may be sensitive to a broad waveband, enough to encompass both the fundamental and several of the harmonic frequencies. Thus, damage could be done if the harmonic frequencies get unstable, even if the fundamental frequency were to remain within control.

Another example where RF energy control is critical is the industrial deposition of thin films that use RF energy for RF sputtering. Frequencies outside the standard ISM frequencies are sometimes employed such as 400 kHz and 13.56 MHz. Sputtering deposition is a well-known methodology of applying a coating of several atomic or molecular layers of target material onto a substrate. The coating, which is generally less than about 1 μm, is call a thin film, and the process is referred to as sputter deposition. It consists of bombarding a target material, within a vacuum chamber, with atoms ejecting target material atoms. Because a target material is bombarded and its atoms are ejected to coat a substrate with a thin film, stray ejected atoms also will coat the chamber wall with a secondary material deposition. When processes use various controlled coatings in a step-by-step multi-film deposition, it is critical not only to control the RF energy for proper film deposition thickness but also to detect and remove any residual target material from the chamber wall in order to render the subsequent step without causing contamination of the substrate. This is a time consuming process requiring use of spectrum analyzers to detect stray material between process steps. RF sputtering is sensitive to RF power changes and power fluctuation will lead to a lack of control within a process. Impurities generated during the sputtering process can be detected as a change in the amplitude relationship between the fundamental frequency and any of its harmonics. Uncontrolled changes in the RF fundamental frequency amplitude and/or any of its harmonics will create uncontrollable effects on the substrate. The RF generator's energy output stability is a direct function of the process control. Process control problems will arise if the fundamental or harmonic amplitude either increase or decrease.

Plasma deposition is another RF energy release deposition process. Solid matter is transformed first to a liquid, then to a gaseous state. If further energy is added, the kinetic energy of the gas increases to a point where electrons become detached from the atoms or molecules during collision. The resulting mixture is called plasma. RF energy control is critical to control this process.

Another area where RF energy control is critical is the process of crystal growth. A silicon crystal growth is a time consuming process; and any contamination can render a large defect level in the chips produced from the crystal or even a scrapping of the entire crystal itself.

There are many other areas too extensive to mention herein where basic RF energy control is critical to process control itself. In many applications prior art process control relies heavily on the use of spectrum analyzers where control is basically a function of after-process parameters. Spectrum analyzers require manual adjustments, use a sweep range to detect material presence, have time-consuming setup requirements and are expensive limiting the ability to have one at each station within a manufacturing process.

What is needed is a real-time process measurement of RF energy output. What is also needed is the ability to provide real-time feedback of any RF energy variation to a process in order to stabilize and improve control.

The method and apparatus of the present invention will solve these needs as will be explained in the proceeding description and drawings.

### III. SUMMARY OF THE INVENTION

The major aspect of the present invention is to provide an improvement in the process and control in some processes utilizing RF generated power.

Another aspect of the present invention is to provide a vehicle for improving process controls not currently available in the industry.

Yet another aspect of the present invention is to detect and provide near instantaneous feedback on a primary RF frequency and its harmonics.

Still another aspect of the present invention is to provide the ability to provide correlation between production parameter changes and RF power changes.

Another aspect of the present invention is to provide a time-stamp correlation between controlled RF energy versus manufacturing output parameters.

Another aspect of the present invention is to provide a means to improve manufacturing time via better process control.

Another aspect of the present invention is to provide a method to self-calibrating a process, which utilizes RF energy.

Another aspect of the present invention is to provide a process control which will lower scrap cost, improve reliability and lower total cost.

The present invention provides an apparatus that provides process control via a circuit that is capable of providing feedback for any applications that utilize RF energy, especially where harmonic power spectra changes affect the outcome of end product parameters.

The invention utilizes a circuit, which samples one, or a plurality of, fundamental RF frequencies Fₙ and each fundamental frequency's related harmonics Fₙ₁, Fₙ₂, . . . Fₙₓ. The circuit processes any change in harmonics, digitizes the change data, time stamps and logs the results. The circuit also allows for a display of the data, selection of the frequency to be displayed, logging of the data and sending of the data to an upstream process controller for further analysis or production parameter correlation.

Other aspects of this invention will appear from the following description and appended claims, reference being made to the accompanying drawings forming a part of this specification wherein like reference characters designate corresponding parts in the several views.

### IV. BRIEF DESCRIPTION OF THE DRAWINGS

FIG. 1A is a simple illustrative view of a prior art medical application with an RF generator, a probe and a target sample.

FIG. 1B is a diagram of the tissue sensitive bandwidth as compared with the RF fundamental frequency and harmonics.

FIG. 2 is a simple illustrative view of a prior art RF sputtering set up.

FIG. 3 is a simple illustrative view of the present invention control process integrated with a RF sputtering set up.

FIG. 4 is a simple illustrative view of the present invention control process integrated with a plurality of frequencies sampled.

FIG. 5 is a block diagram showing the precision splitter, fundamental and harmonic filters; log comparators, A/D converters and digitizer microprocessor for the present invention.

FIG. 6 is an extended block diagram of FIG. 5 showing a plurality of fundamental frequency precision splitters, fundamental and harmonic filters, log comparators, and A/D converters.

FIGS. 7A, 7B are an overall block diagram of the preferred embodiment circuit implementation of the present invention.

FIGS. 8, 9, 10 are a simple flow chart of software for each microprocessor.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### V. DETAILED DESCRIPTION OF INVENTION

The present invention provides an improvement in the process and control in any process utilizing RF generated power. The method and apparatus of control is not currently available within the industry. Utilization of microprocessors and other circuitry detects and provides near instantaneous feedback on a primary RF frequency and its harmonics. For purposes herein a first order harmonic (or second harmonic) is two times the fundamental frequency, a second order (or third harmonic) is three times the fundamental frequency and so forth. If a fundamental RF frequency were 13.5 Mhz, then its second harmonic would be 27 Mhz, and its third harmonic would be 40.5 Mhz. Data provided is time-stamped and can be used for correlation between production parameter changes and RF power changes. Improvements in the manufacturing or other medical or industrial process will lead to improved efficiencies including cost, yield, reliability and overall to better process control.

The circuitry of the present invention also allows a user to self-calibrate the application process, thus insuring functionality of the circuitry and feedback data.

The apparatus of the present provides process control via a circuit that provides feedback for any applications that utilize RF energy, especially where harmonic power spectra changes affect the outcome of end product parameters. It should be noted that the circuit description below is that of the preferred embodiment only and that the present invention could employ other circuit designs to perform the same control function.

The invention utilizes a circuit, which samples one, or a plurality of, fundamental RF frequencies Fₙ and each fundamental frequency's related harmonics Fₙ₁, Fₙ₂, . . . Fₙₓ. Initial, real time samples are taken by a RF sampler device, split to each fundamental frequency and sent through respective filters for each fundamental and related harmonic frequency(s). A selector matrix, controlled by a mode selector switch, outputs a selected fundamental frequency Fₙ and its related harmonic frequencies Fₙ₁, Fₙ₂, . . . Fₙₓ. The circuit then detects amplitude changes via a harmonic analyzer for each frequency Fₙ, Fₙ₁, Fₙ₂, . . . Fₙₓ. The amplitude change of the fundamental frequency is in comparison to reference frequency signal amplitude F_{ref} whereas harmonic amplitudes are compared to the fundamental frequency Fₙ. Typically the second harmonic Fₙ₁, and the third harmonic Fₙ₂ are of primary interest. It should be noted that the preferred embodiment of the present invention is concerned with the fundamental frequency Fₙ, and only with the first two harmonic frequencies Fₙ₁, Fₙ₂. It should also be noted that this invention is not limited to detection of changes in only the first two harmonics but that a plurality of harmonics could also be detected depending on user requirements.

There are three microprocessors in the preferred embodiment of the present invention. Continuing to explain the circuitry flow, the aforementioned amplitude changes are then digitized via an analog to digital (A/D) converter and sent to a first ‘digitizer’ microprocessor, which then formats the data and processes it to an internal output serial buss. The ‘digitizer’ microprocessor also contains memory with normalization coefficients related to error correction (or normalization) of offset and gain. This is stored as normalization code with data to correct initial system variations. Offset and gain or multiplication error correction coefficients within the memory handle any specific component or application variations and are set up during initial manufacture. This allows for initial system calibration with respect to National Institute for Standards (NIS) reference standards. Procedures for offset and gain coefficients are well known in the art. A second ‘data logger’ microprocessor temporarily stores the incoming digitized data, time-stamps the data and processes it out to a buss for any further upstream processing. The outbound buss utilized in the preferred embodiment of the present invention is an RS232 buss. The incoming digitized data is also inputted to a third ‘master’ microprocessor that has several functions. It serves to display the data associated with a fundamental frequency and respective harmonics that are selected by input from a mode selector switch and also to send the selection information to the aforementioned selector matrix via the internal serial buss and via the ‘digitizer processor’, which communicates the information as an input to the selector matrix. The ‘master’ microprocessor also had control switch inputs and acts to power up the entire system etc. Each microprocessor also has dedicated EPROM program memory.

Thus, the present invention serves to provide a control apparatus and method that to RF frequency data, including fundamental and harmonic frequencies, on a real-time basis and notifies an upstream system of the status of the RF energy via the sampled data. The data providing amplitude changes in the aforementioned frequencies, which in turn, will provide RF power changes. RF power changes are of prime concern to having a process control within most any application where RF energy is utilized.

Although the present invention has been described with reference to preferred embodiments, numerous modifications and variations can be made and still the result will come within the scope of the invention. No limitation with respect to the specific embodiments disclosed herein is intended or should be inferred.

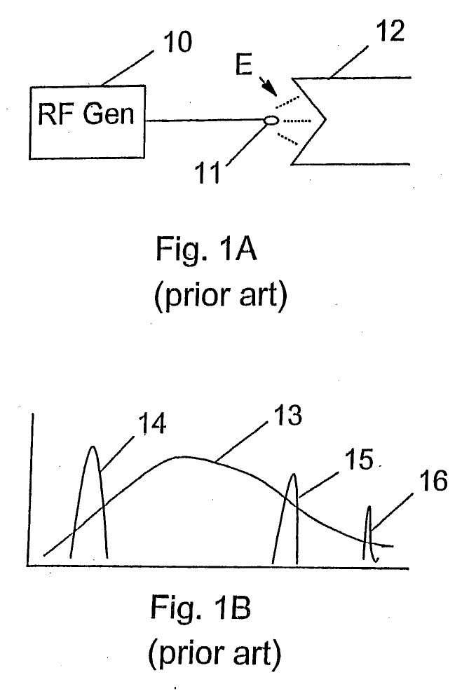

Referring now to the drawings, FIG. 1A is an illustrative view of a prior art medical application with an RF generator 10, an RF probe 11, and a target tissue area 12. RF energy E emitted from probe 11 is employed to subjugate or destroy the target tissue area 12 of concern. FIG. 1B is a diagram of the aforementioned tissue sensitive bandwidth as compared with the bandwidth of RF fundamental frequency 14 and its second harmonic bandwidth 15 and third harmonic bandwidth 16. If either the basic fundamental RF frequency 14 and/or combinations of any its harmonic frequencies 15, 16 are unstable, tissue could be harmed beyond the initial intent. Harmonics instability would be particularly harmful in that the tissue waveband 13 could be wide enough (as shown) to encompass both the fundamental and the harmonic frequencies. Thus damage could be done if the harmonic frequencies have contributing RF power amplitudes, even if the fundamental frequency were to remain within control.

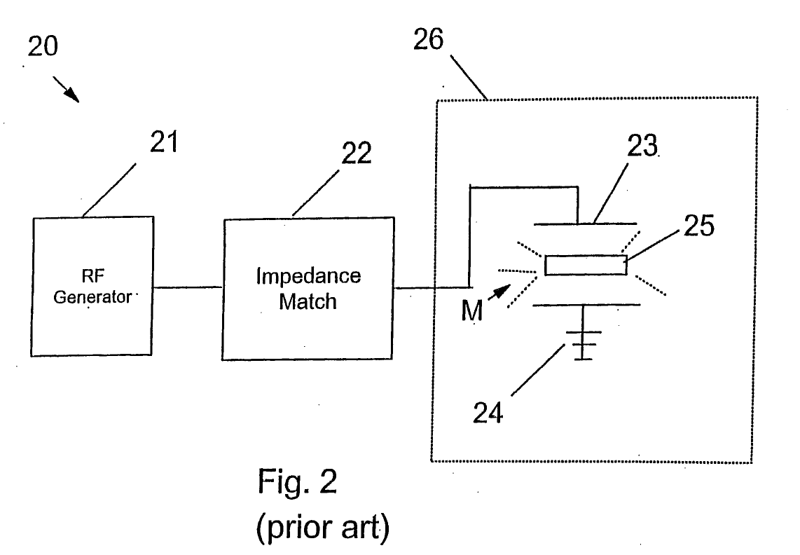

FIG. 2 is a simple illustrative view of a prior art RF sputtering set up 20. RF generator 21 supplies energy through an impedance match network 22 to a vacuum chamber 26 containing an anode 23, ground 24 and target material 25. Atoms M of target material 25 are released via the RF energy onto a substrate (not shown) to form a coating. The coating is generally less than about 1 μm. Stray ejected atoms M also coat the chamber 26 walls with a secondary material deposition. When processes use various controlled coatings in a step-by-step multi-film deposition, it is critical not only to control the RF energy for proper film deposition thickness but also to detect and remove any residual target material from the chamber 26 walls to avoid contamination of the substrate. Uncontrolled changes in the RF fundamental frequency amplitude or bandwidth and/or any of its harmonics will create uncontrollable effects on the substrate. RF generator 21 energy output stability is a direct function of the process control. Process control problems will arise if the fundamental or harmonic broadband or amplitude either increase or decrease thereby causing out-of-spec or contamination conditions.

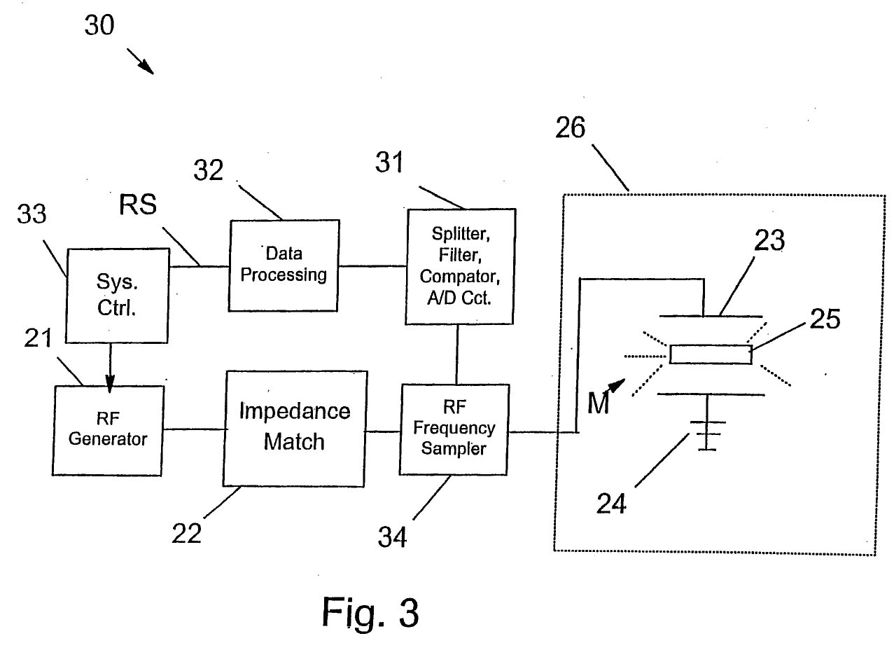

FIG. 3 is a simple illustrative view of the present invention control process integrated with a RF sputtering set up. The sputtering integrated system 30 consists of RF frequency sampler 34, which is added (ref. FIG. 2) to sample RF energy input. RF frequency sampler 34 can be designed to have a plurality of outputs, thereby sampling one or more RF energy frequencies. Circuit 31 acts to split frequencies, compare power levels of selected fundamental and harmonic frequencies, and data processing circuit 32 processes data, time stamps data, and provides RS232 serial output RS to system controller 33 which then can utilize the data to make any necessary adjustment to RF generator 21. A more detailed description of circuitry for the preferred embodiment of the present invention will be discussed below. Having a system that provides real-time data enables process control, correlation with finished product parameters, and many other advantages. Although FIG. 3 depicts the present invention integrated with a sputtering system, any application that utilizes RF energy is applicable to the method and apparatus of the present invention. It should be noted that system controller 33 can be embodied within the circuitry of the present invention thereby providing a closed loop control system.

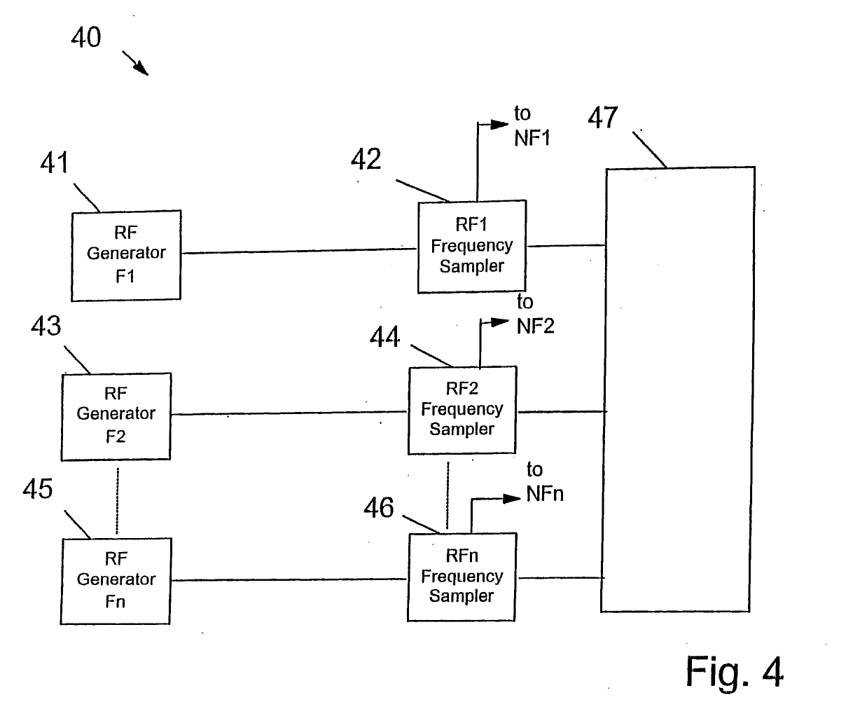

FIG. 4 is a simple illustrative view of the present invention control process integrated with a plurality of RF frequencies F1, F2, . . . Fn. supplied and sampled, an extension of FIG. 3 above into a process 47. In this configuration RF generator F1 41 utilizes fundamental frequency F1 and RF frequency sampler 42 samples F1 and its harmonics sending output to network NF1 (not shown) to process F1 in the aforementioned manner. Likewise, RF generator F2 43 utilizes fundamental frequency F2 and RF frequency sampler 44 samples F2 and its harmonics sending output to network NF2 (not shown). A plurality of RF generators Fn 45 and associated RFn frequency samplers 46 can be utilized for more complex process control systems.

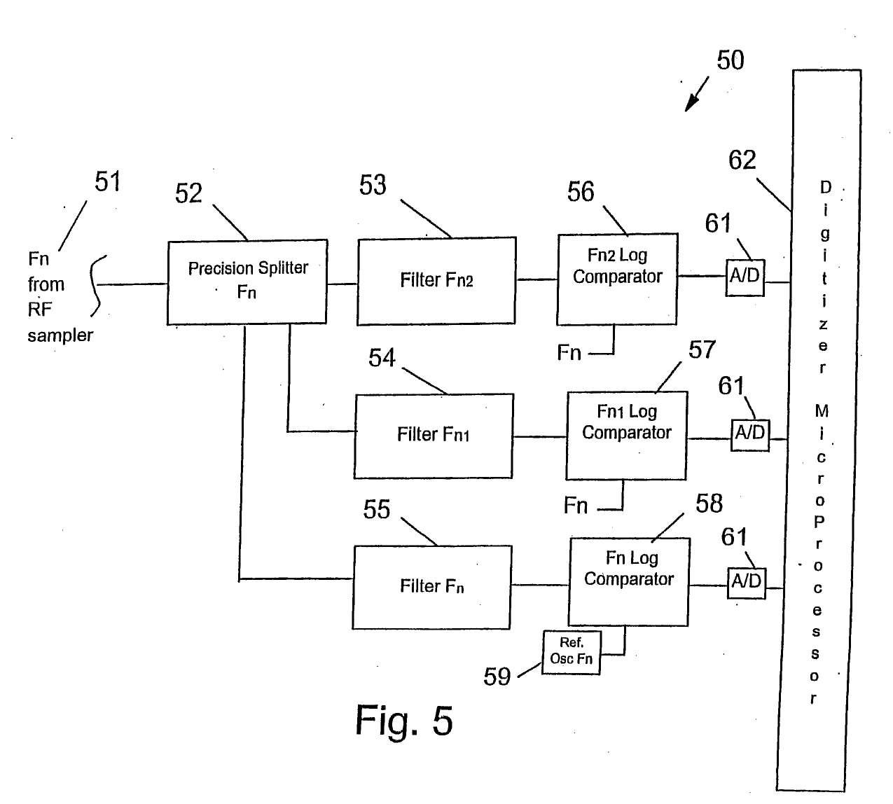

FIG. 5 is a block diagram showing various circuit components. Precision splitter 52 functions to split and output a fundamental frequency Fₙ and its related second harmonic Fₙ₁ and third harmonic Fₙ₂. Although only two related harmonics are depicted, precision splitters can be designed to output any plurality of harmonics. Outputs from precision splitter 52 are inputted to respective filters. Fundamental frequency Fₙ filter 55, second harmonic Fₙ₁ filter 54, and third harmonic Fₙ₂ filter 53 function to filter out any extraneous frequencies or noise. The outputs of the filters are inputted to respective log comparators that compare the amplitude of the inputted frequencies with another referenced input. Filtered fundamental frequency Fₙ is inputted to Fₙ log comparator 58. Fₙ log comparator 58 provides an output that references the amplitude of Fₙ with reference oscillator 59 input. The output of Fₙ log comparator 58 output is a logarithmic ‘delta’ or difference between input Fₙ amplitude and reference oscillator 59 amplitude. Reference oscillator 59 will have an input that will be set at frequency Fₙ and at reference amplitude. Thus the output of log comparator 58 will be an analog signal that is a ‘difference’ between its input Fₙ amplitude and the reference amplitude. In a similar manner, Fₙ₁ log comparator 57 has an output referenced to the amplitude of Fₙ, as does Fₙ₂ log comparator 56. A/D converters 61 digitize all analog signals prior to each signal being inputted to digitizer microprocessor 62. Thus, this circuit is able to output amplitude-referenced digitized signals for the fundamental frequency Fₙ, and its respective harmonics Fₙ₁, Fₙ₂. These amplitude-referenced signals can thus be continuously processed and monitored for any changes of amplitude. The present invention thus allows the ability to monitor and detect RF signal power level and associated changes in fundamental frequencies and associated harmonics. Although FIG. 5 only depicts two harmonics, other harmonics can easily be incorporated by increasing precision splitter 52 outputs and adding additional filters and log comparators.

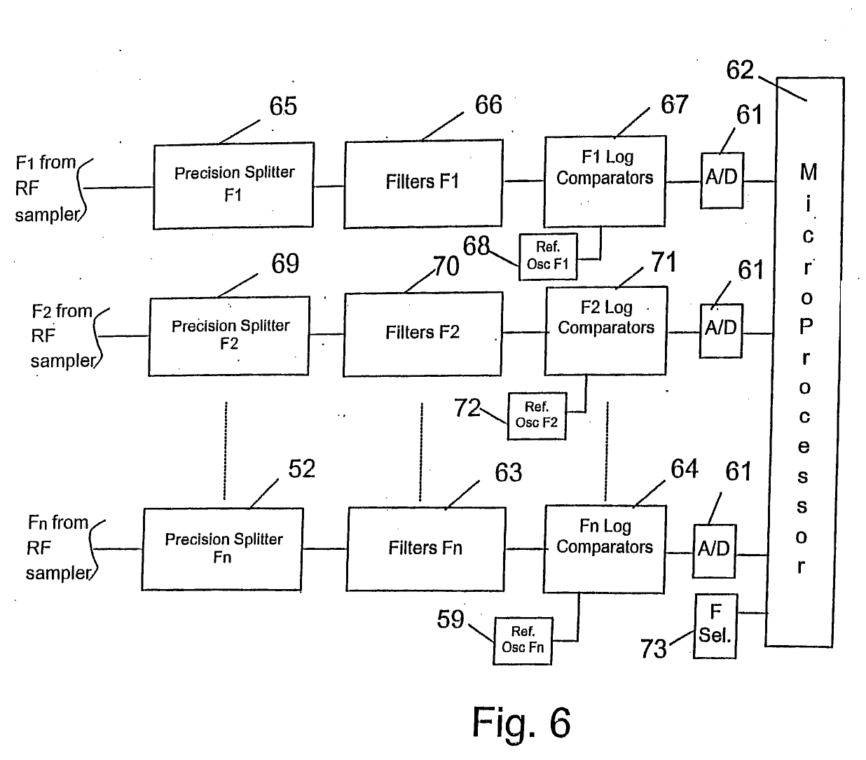

FIG. 6 is an extended block diagram of FIG. 5 showing a plurality of fundamental frequency precision splitters, fundamental and harmonic filters, log comparators, and A/D converters. All fundamental frequency inputs are originated in an RF sampler (not shown). As described in FIG. 5 above, each precision splitter F1 65, splitter F2 69, and splitter Fn 52 will output the respective fundamental frequency and respective harmonics. Filter Fn 63, filter F1 66, and filter F2 70 function to filter each fundamental and respective harmonic and send them to F1 log comparators 67, F2 log comparators 71, and Fn log comparators 64 respectively. All log comparators have a reference amplitude signal from each respective reference oscillator F1 68, reference oscillator F2 71, or reference oscillator Fn 59. All log comparator outputs are converted from analog to digital signals via their respective A/D converters 61. Microprocessor 62 will process an input fundamental frequency and its harmonics depending on the input from frequency selector circuit 73.

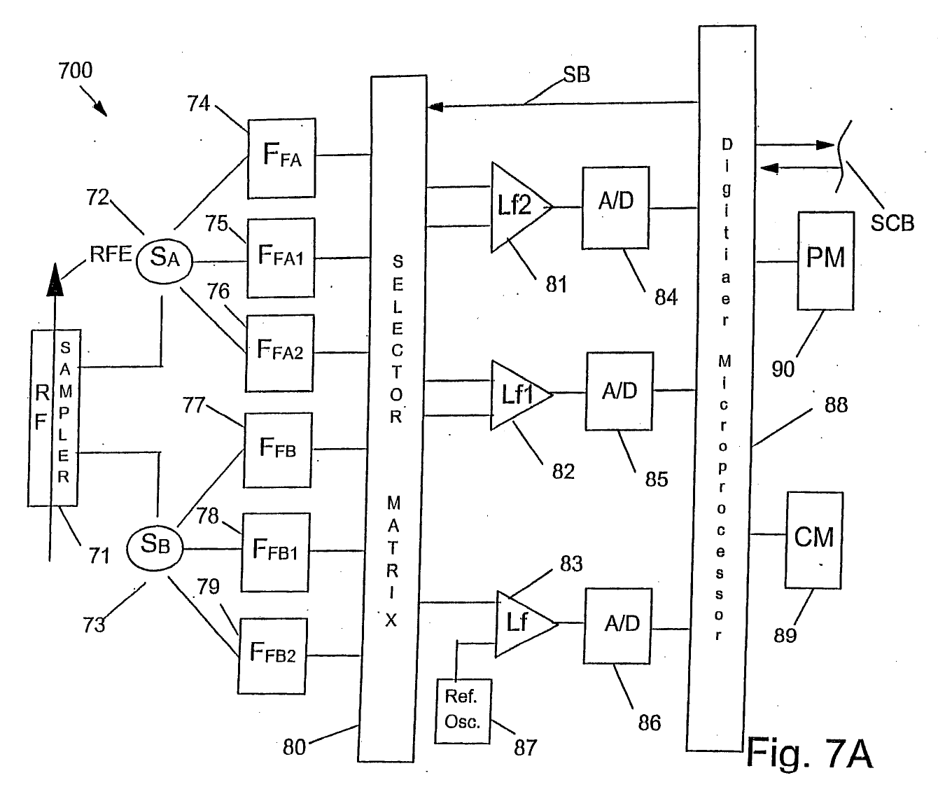

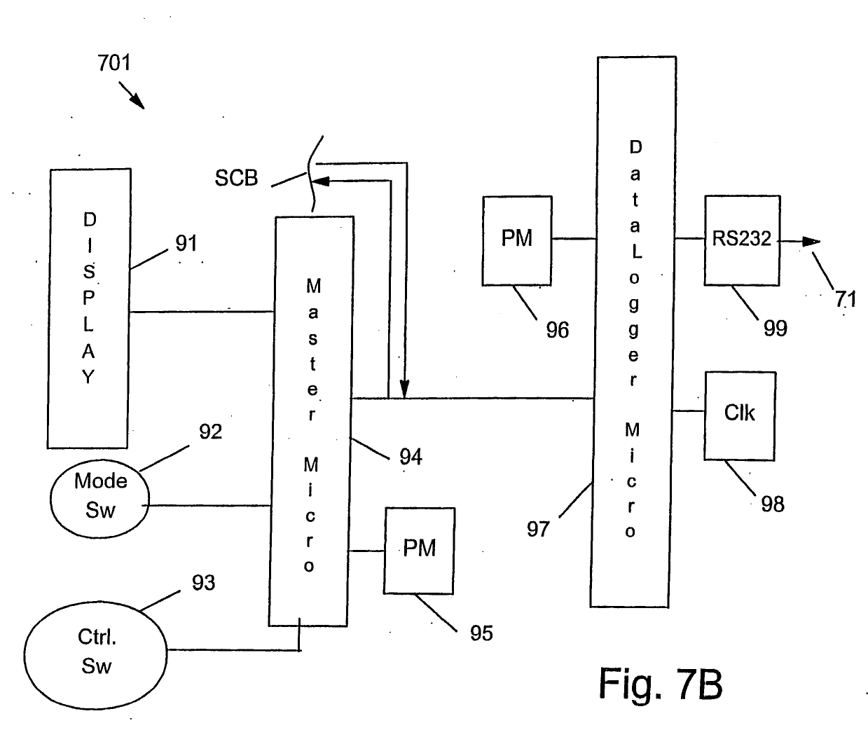

FIGS. 7A, 7B are an overall block diagram of an exemplary and preferred embodiment circuit implementation of the present invention. It should be noted that other circuit implementations are possible to accomplish the same method of the present invention. The preferred embodiment of the present invention is concerned with the second harmonic Fₙ₁, and the third harmonic Fₙ₂ although it is a simple matter to extend the circuitry to more than two harmonics. The following description of the preferred embodiment utilizes sampling of two fundamental frequencies and two harmonics per fundamental frequency. It should be noted that other configurations are easily configurable.

FIG. 7A circuitry 700 functions to sample and process initial data from a RF frequency signal RFE that is generated and being used for a particular application. RF frequency signal RFE may contain a plurality of frequencies for a particular application. The exemplary circuit describes two fundamental frequencies. Real time RF samples are taken by RF sampler 71 device. In the following discussion the two fundamental frequencies discussed are F_{A} and F_{B}. S_{A} splitter 72 splits F_{A} into its first order harmonic F_{A1} and its second order harmonic F_{A2}. S_{B} splitter 73 splits F_{B} into its first order harmonic F_{B1} and its second order harmonic F_{B2}. Each fundamental frequency (F_{A}, F_{B}) and respective harmonics (F_{A1}, F_{A2}, F_{B1}, F_{B2}) are then transmitted through respective filters. F_{A} sent to F_{A} filter 74, F_{A1} to F_{A1} filter 75, F_{A2} to F_{A2} filter 76. In a similar manner, F_{B} is sent to F_{B} filter 77, F_{B1} to F_{B1} filter 78, F_{B2} to F_{B2} filter 79. Selector matrix 80, indirectly controlled by a mode selector switch (ref. FIG. 7B) receives input from selector buss SB and acts as a multiplexer to pass either F_{A} and its respective harmonics or F_{B} and its respective harmonics, depending on the input from selector buss SB. The selected fundamental frequency and its related harmonic frequencies are outputted to log comparators that detect amplitude changes via a harmonic analyzer. If we assume RF frequency F_{A} is selected, the amplitude change of the fundamental frequency F_{A} is analyzed in comparison to a reference frequency signal amplitude F_{ref} outputted by reference oscillator 87 and inputted into Lf log comparator 83. The output of Lf comparator 83 is the ‘difference’ between the power level of the fundamental frequency F_{A} and the amplitude of the reference oscillator input frequency F_{ref}. The analog output of Lf comparator 83 is sent to analog-to-digital (A/D) converter 86 where it is transformed to a digital signal and then inputted to ‘digitizer’ microprocessor 88. In the same manner harmonic F_{A1} is inputted into Lf1 log comparator 82. Lf1 log comparator 82 also receives F_{A} as the comparison input. Thus the output of Lf1 log comparator 82 is the ‘difference’ between the power amplitudes of the fundamental frequency being sampled, F_{A} and its second harmonic F_{A1}. The output of Lf1 log comparator 82 is sent to A/D converter 85, digitized and sent to ‘digitizer’ microprocessor 88. Likewise, third harmonic F_{A2} is inputted into Lf2 log comparator 81. Lf1 log comparator 81 also receives F_{A} as the comparison input. Thus the output of Lf2 log comparator 81 is the ‘difference’ between the power amplitudes of the fundamental frequency being sampled, F_{A} and its third harmonic F_{A2}. Output of Lf2 log comparator 81 is sent to A/D converter 84, digitized and sent to ‘digitizer’ microprocessor 88. If selector buss SB were to request sampling from RF frequency F_{B}, then F_{B} and its respective harmonics would be sent through selector matrix 80 and into the aforementioned log comparators. The outputs of each log comparator contain information on the RF energy of the selected fundamental frequency and respective harmonics and are thus available for process control action on an immediate basis. ‘Digitizer’ microprocessor 88 has its program memory 90 for its micro-code storage and also a calibration (or normalization) memory 89, which is used for system normalization. System normalization will be discussed below. ‘Digitizer’ microprocessor 88 formats the incoming sampled RF frequency data and processes it to internal input/output (I/O) serial buss SCB.

Now referring to FIG. 7B circuitry 701. I/O serial buss SCB communicates with ‘data logger’ microprocessor 97 that temporarily receives and stores the incoming digitized data, time-stamps the data and processes it out to RS232 buss 71 for any further upstream processing. RS232 buss 71 also receives time stamp data from upstream to initialize the proper time stamp into real time clock 98. ‘Data logger’ microprocessor 97 has its program and data memory 96 and real time clock 98, which is utilized to time-stamp data. Incoming digitized data is also inputted, via I/O serial buss SCB, to ‘master’ microprocessor 94 that has several functions. It serves to display the data associated with a selected fundamental frequency and respective harmonics. RF frequency selection is accomplished via mode selector switch 92. Mode selector switch 92 could be set, for example, to select only the high or select only the low frequency, or it could be set to sample both frequencies on a time shared basis. RF frequency selection is also sent to the aforementioned selector matrix via the internal serial buss SCB and then via the ‘digitizer processor’ on buss SB (FIG. 7A) as an input to selector matrix 80 (FIG. 7A). ‘Master’ microprocessor 94 also has control switch inputs 93 and acts to power up the entire system etc. Control switch 93 could also be designed to control other functions as display of current time or other user interface controls. It should be noted that the aforementioned preferred embodiment circuitry of FIGS. 7A, 7B could easily be expanded to encompass more than two fundamental frequencies. It should also be noted that other circuit designs could be employed to perform the same basic functions as that described herein and that the present invention is not limited to the aforementioned circuit design.

Data packets sent upstream on RS232 buss 71 consist of three types of packets. Packet number one would contain the frequency-selected mode. For purposes of example, if a sputtering operation were using two fundamental frequencies, 400 kHz and 13.56 MHz, it would identify the frequency selected by mode switch 92. Mode switch 92 could select 400 kHz, or 13.56 MHz, or select a time-share mode whereby both frequencies would be sent time shared basis. It would also contain the month, day, year, hour, minute, second time stamp information.

The second packet would contain the information concerning the higher frequency, if it were selected. If it were not selected, the packet would contain superfluous information:
a) frequency-selected identification, for example identify 13.56 MHz as the selected frequency;
b) ‘dbm’ information, which is the decibel to milliwatt ratio of the selected fundamental frequency to the reference frequency signal amplitude F_{ref} (ref. oscillator 87, FIG. 7A) as outputted by Lf comparator 83 (FIG. 7A) and subsequently digitized;
c) ‘dbc1’ information, which is the decibel ratio of the second harmonic to the selected fundamental frequency. For example if 13.56 MHz were selected, the second harmonic would be 27.12 MHz. Then ‘dbc1’ would be the output of Lf1 comparator 82 subsequently digitized;
d) ‘dbc2’ information, which is the decibel ratio if the third harmonic to the selected fundamental frequency. For example if 13.56 MHz were selected, the third harmonic would be 40.68 MHz. Then ‘dbc2’ would be the output of Lf2 comparator 81 subsequently digitized.

The third packet would contain the information on the lower frequency (400 kHz in this example) when it is selected. Other exemplary packet configurations are possible without departing from the scope of the present invention.

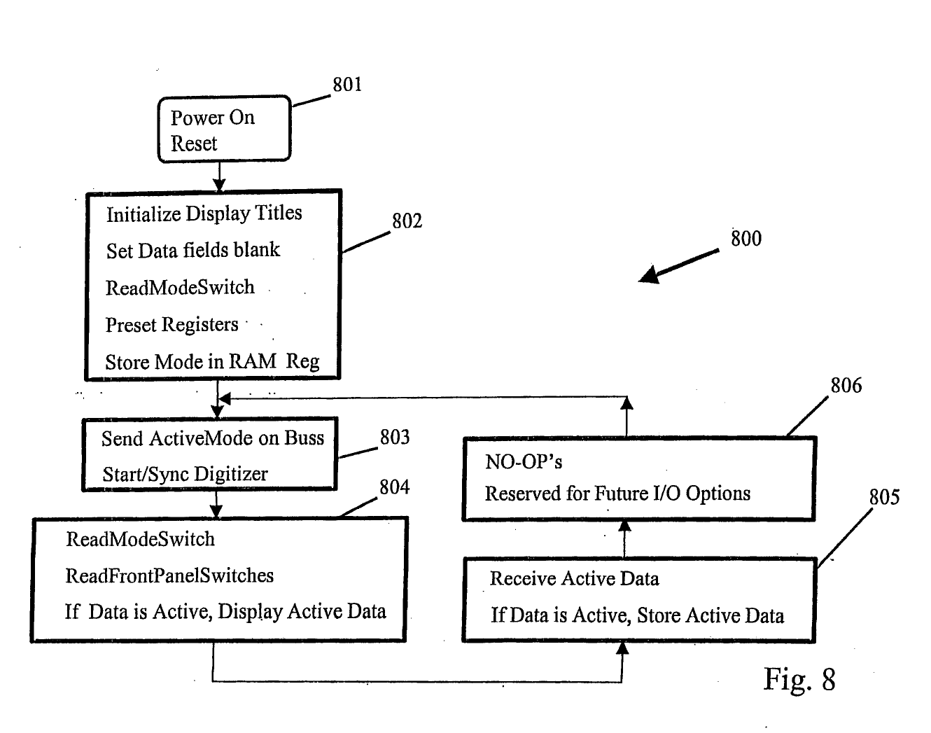

FIG. 8 is a simple flow chart of master μp software 800 for master microprocessor 94 (ref. FIG. 7B). Initialization begins with power on reset 801, then initialization step 802 initializes the display, sets data fields to a blank, reads the mode switch, presets all registers and stores the current set mode into the processor RAM register. Next the active mode is sent out to the internal serial buss, and the digitizer is initialized and synchronized, step 803. Next, the mode switch is read again, the front panel control switches are read and any active data is displayed, step 804. Next, any new active data is received and stored, step 805. Step 806 is a temporary no-op step reserved for future upgrades or user requirements. Then there is a return to step 803 where the active mode is sent to the internal serial buss and the digitizer is again synchronized to restart the loop.

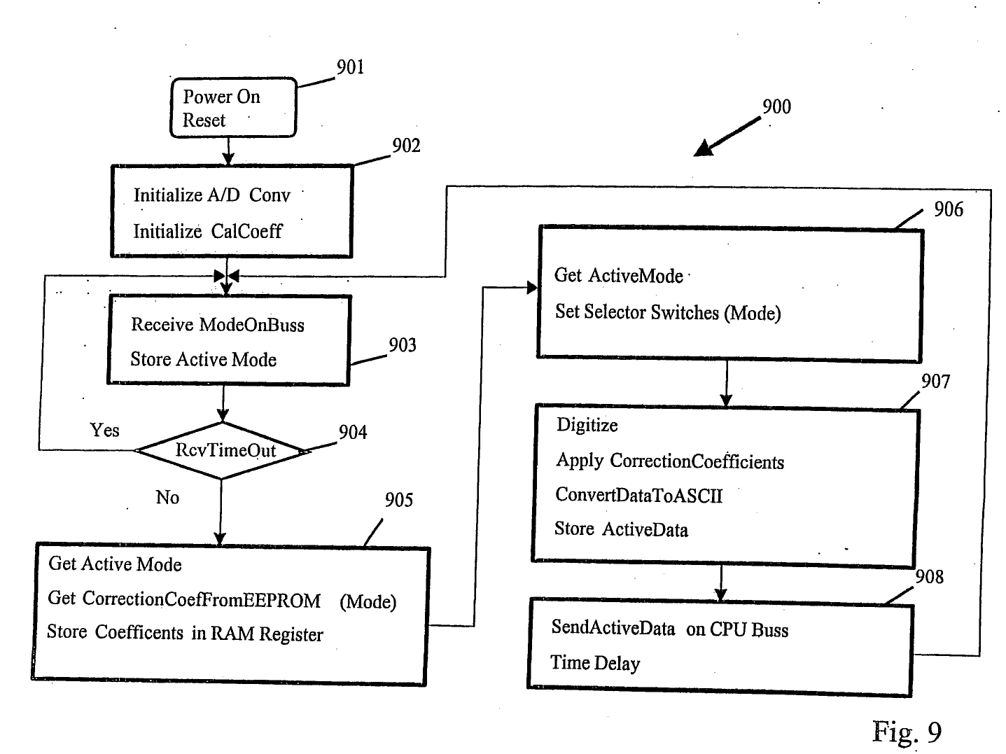

FIG. 9 is a simple flow chart of digitizer μp software 900 for digitizer microprocessor 88 (ref. FIG. 7A). Initialization begins with power on reset 901. This is followed by initialization of the A/D converters and the stored normalization coefficients, step 902. The internal serial buss is sampled to get the active mode and the active mode is stored, step 903. A time out returns to look at the serial buss if no active mode was received, step 904. If an active mode was received, the active mode is retrieved from memory, correction coefficients used for system normalization are retrieved from memory and stored in the processors active RAM memory, step 905. The next step 906, comprises setting the selector switches, depending on the active mode, to pass through the selected fundamental frequency and its related harmonics. Step 907 comprises formatting the digitized data of the input fundamental and harmonic, applying correction coefficients to correct and to normalize the data, converting data from binary to ASCII and storing the data. Correction coefficients are derived during system normalization procedures. Active data is then sent out on the internal serial buss with proper time delays, step 908 such that the master microprocessor and data logger microprocessor will receive it. The process then loops back to step 903 to sample and receive the current mode.

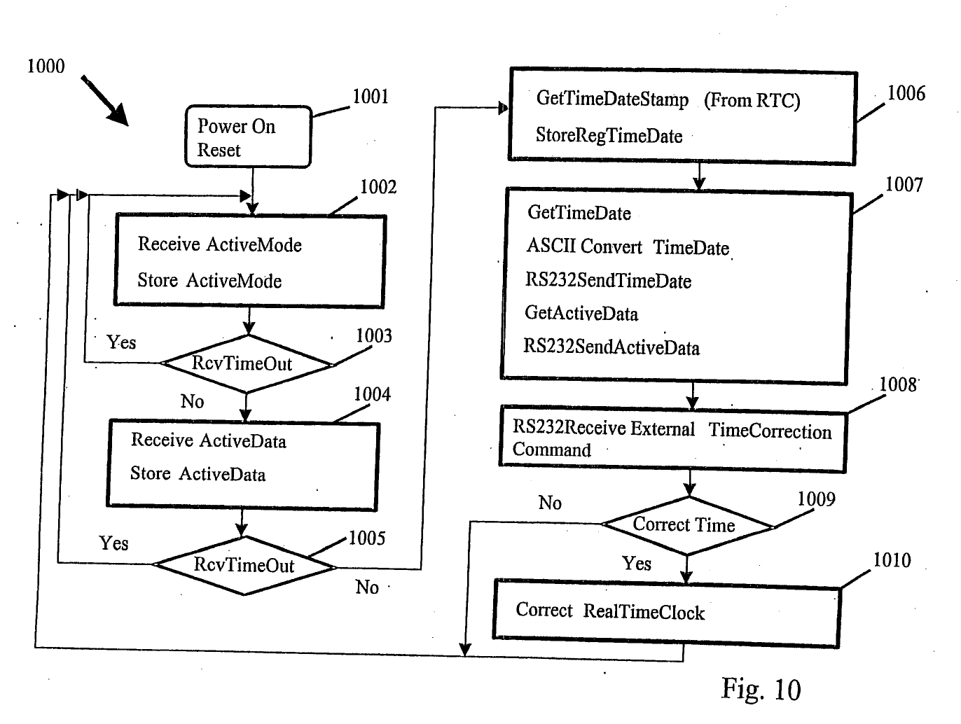

FIG. 10 is a simple flow chart of data logger μp software 100 for data logger microprocessor 97 (FIG. 7B). Initialization begins with power on reset, step 1001. The current active mode is received from the internal buss and stored, step 1002. Next a time out step 1003 times out to resample the buss if no active mode is received or continues to the next step if an active mode is received. The internal serial buss is then sampled to receive active data and store the data, step 1004. A decision, step 1005, to return to sample the active mode, step 1002, is done if no data is present. If data is present the time out does not occur and the process moves to step 1006 where a time clock is retrieved from the real time clock and stored with respect to the active data. Then, step 1007, the time stamp info is converted to ASCII and packet one is sent out with mode information to the RS232 buss. Also the active data is retrieved and the aforementioned packet two is sent out to the RS232 buss. In the next step 1008, an external time correction command could be received from the RS232 buss. If received the real time clock is corrected, step 1010. If no time correction is received, the process moves back to step 1002 to start through the loop again.

It should be noted that although the above hardware and software aspects of the present invention have been described with reference to a particular exemplary embodiment, it will be understood that addition, deletions and changes may be made to the exemplary embodiment without departing from the scope of the present invention.

The present invention thus provides a method and apparatus to enable process control via the aforementioned circuit that is capable of providing RF power stability feedback for any applications that utilize RF energy, especially where harmonic power spectra changes affect the outcome of end product parameters.

We claim:

1. A method of sampling RF energy, comprising the steps of:
a. sampling RF energy;
b. splitting said RF energy sampled;
c. filtering said RF energy sampled; and
d. measuring differences between the fundamental frequency amplitude of said RF energy sampled and a reference frequency amplitude.
